(19) United States
(12) Patent Application Publication
(10) Pub. No.: US 2005/0003781 A1
(43) Pub. Date: Jan. 6, 2005

(54) Multiple format radio frequency receiver

(75) Inventors: William E. Kunz, Foster City, CA (US); Garo Sarkissian, Redwood City, CA (US)

Correspondence Address: BEYER WEAVER & THOMAS LLP, P.O. BOX 778, BERKELEY, CA, 94704-0778, US

(73) Assignee: California Eastern Laboratories

(21) Appl. No.: 10/641,676

(22) Filed: Aug. 14, 2003

Related U.S. Application Data
(60) Provisional application No. 60/484,623, filed on Jul. 2, 2003.

(51) Int. Cl. H04B 17/00

(52) U.S. Cl. 455/226.1

(57) ABSTRACT

RF receiver topologies and systems incorporating such topologies are described. Various implementations allow the intelligent monitoring of transmission formats, multi-format reception, and real-time receiver parameter optimization.

### RELATED APPLICATION DATA

The present application claims priority from U.S. Provisional Patent Application Ser. No. ______ for DUAL MODE FSK/FM & ASK/AM RECEIVER filed Jul. 2, 2003 (Attorney Docket No. CEL1P001P), the entire disclosure of which is incorporated herein by reference for all purposes.

### BACKGROUND OF THE INVENTION

The present invention relates to radio frequency (RF) receivers and, more specifically, to RF receivers which support multiple radio transmission formats.

Many commercially available RF receivers support reception of only a single transmission format. On the other hand, some specialized receiver chips are required to receive transmissions with different formats within the same radio frequency channel. Some current solutions switch the receiver operational mode between the different formats so only one type of transmission can be received at a time. Many times this involves duplicative circuitry. In addition, such solutions eliminate reception of the non-selected formats, essentially blanking the receiver to any information transmitted in such formats during such blanking intervals.

In addition to cycling between formats, such specialized receivers typically cycle between the on and off states. For example, some receivers invoke timer based cycling of DC power in an effort minimize power dissipation and thereby maximize battery life. In effect, timer based approaches simply turn reception on and off and attempt to fortuitously “catch” transmitted signals. Since the transmitters sending messages to these receivers may not have good timing stability or frequency accuracy, these inaccuracies must be taken into account in the design phase, undesirably increasing design complexity. In addition, some transmitters emit signals at near arbitrary times requiring constant or near constant polling of the channel. A keypad with human interaction is a classic example of such random input.

An exemplary specialized receiver chip which is operable to receive signals having multiple formats includes at least one radio frequency (RF) down-converter with one or more local oscillators and frequency references. The down-converter generates a significantly lower frequency rendition of the received RF signal commonly referred to as an intermediate frequency (IF) signal.

The receiver also generates a signal proportional to the average received power level commonly referred to as the receive signal strength indicator (RSSI). Some systems generate the RSSI directly from the received RF signal. Others generate the RSSI or its equivalent in the down conversion detection block, or with circuitry in parallel with the IF amplifier/processing circuitry.

The IF signal is received by demodulation circuitry such as, for example, an FSK demodulator or an ASK demodulator, and the demodulated signal is sent to a micro-controller. A mode control line is operable to alternately enable operation of the FSK and ASK blocks. In a typical application, the selected demodulated signal output is received and decoded by a capture block and processor in the micro-controller.

In addition to alternating between the FSK and ASK modes, the receiver chip may also be turned on and off to conserve power. Thus, for example, when the mode control line is high and the chip is on, the chip operates as an FSK receiver, and when the mode control line is low and the chip is on, the chip operates as an ASK receiver. Such a chip might be employed, for example, to alternately poll for multiple types of signals in an automotive environment including, for example, a remote keyless entry (RKE) signal or a tire pressure measurement system (TPMS) signal.

In addition to the design complexity and receiver blanking issues described above, these switching and signal acquisition events introduce delays and additional battery drain. That is, when a demodulation block is enabled, there is typically a period of time during which the block is getting initialized and acquiring the received signal. For FSK demodulators which employ phase-locked loops to lock onto a received signal, this initialization and acquisition time is relatively long, e.g., 30-40% of the block's on time.

Other compromises in performance may also be associated with the various dual-format receivers on the market. For example, when a receiver is configured to support two formats, it is often not optimally configured for both of the supported formats at the same time. It may also not be optimally configured for an individual format when in that particular mode. Typically the commonality of circuit functions forces compromises in implementation and performance. That is, the demodulator circuitry which receives the raw signals from the different format blocks needs to be able to reliably demodulate both formats at some level of performance. Therefore, it is not typically optimized for one format or the other.

It is therefore desirable to provide techniques and designs by which the foregoing issues are addressed.

### SUMMARY OF THE INVENTION

According to the present invention, RF receivers topologies and systems incorporating such topologies are provided which are operable to receive RF signals using different transmission formats while avoiding some or all of the issues described above. According to a specific embodiment of the invention an RF receiver is provided which includes a down-converter operable to convert a received RF signal to an intermediate frequency (IF) signal. The down-converter is also operable to generate a power detection signal representative of a power level associated with the received RF signal. A hardware demodulator is operable to demodulate the IF signal in accordance with a first modulation format and thereby generate a first demodulated signal. A digital signal processor is operable to process the power detection signal in accordance with a second modulation format and thereby generate a second demodulated signal.

According to another embodiment of the invention, an RF receiver is provided which includes a down-converter operable to convert a received RF signal to at least one intermediate frequency (IF) signal. A first demodulator is operable to demodulate the IF signal in accordance with a first modulation format and thereby generate a first demodulated signal. A second demodulator is operable to demodulate the IF signal in accordance with a second modulation format and thereby generate a second demodulated signal. A micro-controller is operable to decode the first and second demodulated signals. A selector is operable to simultaneously receive the first and second demodulated signals and to provide only one of the first and second demodulated signals to the micro-controller at a time.

According to yet another embodiment of the invention, an RF receiver is provided which includes a down-converter operable to convert a received RF signal to at least one intermediate frequency (IF) signal. A hardware demodulator is operable to demodulate the IF signal in accordance with a first modulation format and thereby generate a first demodulated signal. A software demodulator is operable to demodulate the IF signal in accordance with a second modulation format and thereby generate a second demodulated signal. A micro-controller is operable to simultaneously decode the first and second demodulated signals.

According to still another embodiment of the invention, an RF receiver is provided which includes a down-converter operable to convert a received RF signal to an intermediate frequency (IF) signal. The down-converter is also operable to generate a power detection signal representative of a power level associated with the received RF signal. A demodulator is operable to demodulate the IF signal in accordance with a first modulation format and thereby generate a first demodulated signal. A digital signal processor is operable to process one of the IF signal and the power detection signal to extract information to facilitate any of reception of packetized traffic, channel utilization, power consumption optimization, packet error rate minimization, collision detection, hardware optimization, and demodulation optimization.

A further understanding of the nature and advantages of the present invention may be realized by reference to the remaining portions of the specification and the drawings.

### BRIEF DESCRIPTION OF THE DRAWINGS

FIGS. 1-7 are simplified block diagrams of various specific embodiments of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In addition, well known features may not have been described in detail to avoid unnecessarily obscuring the invention.

According to the present invention, a variety of receiver topologies are provided which address the various issues described above for both one-way and two-way systems. Various specific embodiments allow the intelligent monitoring of transmission formats, multi-format reception, and real-time receiver parameter optimization with regard to, for example, timing, power dissipation, and reception quality. Some embodiments of the invention additionally provide multiple options for processing the received signal.

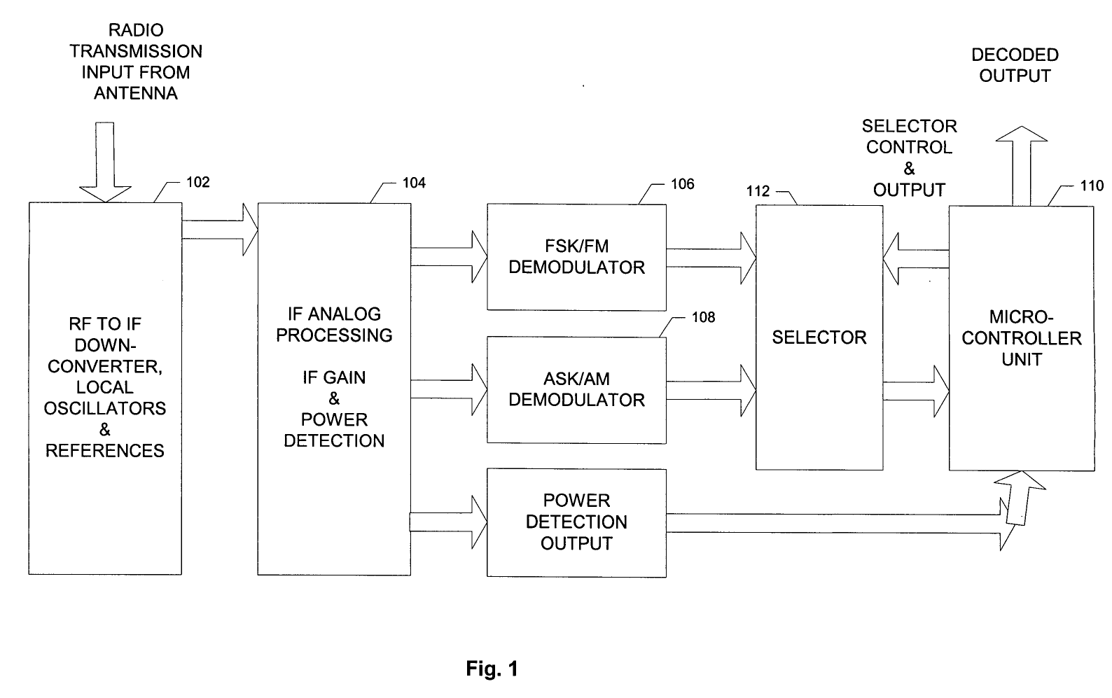

According to a particular class of embodiments, much of the receive chain circuitry (including the demodulation and decision circuitry) may be shared between multiple signal paths corresponding to different modulation formats. According to a specific embodiment, the desired output is selected (e.g., with a multiplexer) after demodulation. An exemplary embodiment is shown in FIG. 1. An RF-to-IF down converter 102 receives an RF signal from the system antenna (not shown) and transmits the resulting IF signal to an IF processor 104 which performs analog processing such as level shifting, buffering, splitting, limiting, and filtering of the IF signal, applies the appropriate gain for subsequent demodulation circuitry, and generates a power detection signal, e.g., an RSSI.

The appropriately processed versions of the IF signal are then provided to corresponding demodulators which demodulate the processed IF signal in accordance with multiple modulation formats. In the exemplary embodiment shown, two demodulators are provided, an FSK/FM demodulator 106 and an ASK/AM demodulator 108. It will be understood that this number of demodulators and these types of modulation schemes are merely exemplary, and that the various embodiments of the invention described above and below may include different numbers of demodulators using any of a wide variety of modulation formats including amplitude modulation formats, frequency modulation formats, phase modulation formats, and complex modulation formats. Such modulation formats may include, but are not limited to, OOK, AM and ASK, FM, FSK, BPSK, QPSK, PSK, N-PSK, OQSPK, N-QAM, and differentially encoded variants thereof. Embodiments including multiple instances of the same or similar types of demodulators (e.g., side-by-side ASK demodulators or side-by-side FSK demodulators) are contemplated. It should also be noted that various embodiments of the invention may employ a wide variety of encoding schemes in conjunction with the various modulation formats, e.g., PWM, PPM, Manchester, Differential Manchester or others. In addition, the frequency channel(s) associated with the different formats may be the same or different, and may correspond to any of a wide range of frequency channels.

IF processor 104 also generates a signal representative of the power level of the IF signal, e.g., an RSSI and may generate multiple replica versions of the IF signal. This signal may be generated by any of a variety of conventional techniques. The RSSI signal may also be buffered, split and conditioned in a output block. The power detection signal is then provided to micro-controller unit (MCU) 110. This power detection or IF replica signal may be used by MCU 110 in a conventional manner and/or to enable various embodiment of the invention as will be described in greater detail below.

A selector 112 receives the demodulated signals from demodulators 106 and 108, and gates the demodulated signals to MCU 110 in a time division scheme according to control signals received from MCU 110. In the case of digital logic levels from an on-chip comparator or digitizer, the selector function may be carried out by a digital 2:1 multiplexer. Alternatively, the same function may be carried out by an appropriate analog switch for either digital or analog outputs. MCU 110 then processes and decodes the selected demodulated signal.

The topology shown in FIG. 1 provides a single input to a signal capture block (not shown) in the MCU. As will be understood, this may have some cost advantages relative to a multiple output implementation. Because the desired demodulated signal is selected immediately before the single output port, each demodulator may be designed to have optimal characteristics with respect to the associated modulation format and frequency channel. This improves the reliability and fidelity of the reproduction of the original information signal modulated onto the RF transmission.

In addition, the demodulators may transition to the on state independently. Thus, with the appropriate timing, the delays associated with signal acquisition, particularly for frequency modulation formats, may be greatly reduced. The time division according to which the demodulated signals are gated to the MCU can be optimized by “learning” the channel and transmitters characteristics. That is, the multiple transmission formats may have vastly different times to first signal demodulation along with different packet durations, repetition rates and base band signaling rates. By observing the demodulator outputs and RSSI levels a controller can derive the timing and characteristics of the packets received by the antenna.

An example of a channel monitor, collision detection and estimator algorithm is given below:
1) Turn on receiver and look for RF power thru RSSI output or on-chip indicators.
2) Attempt to identify energy in signal as a desired signal within the system or an interfering signal.
3) Measure modulation parameters along with individual packet duration and repetition rate.
4) Flag random versus periodic transmissions.
5) Attempt to extract any packet identification and group packets by type of transmitter.
6) Attempt to identify individual transmitters and their characteristics.
7) Start to build a channel traffic model.
8) Examine overlap of packets as possible collisions
9) Predict future traffic patterns based on historic trends
10) Update and verify model, if possible
11) Adaptively control receiver to optimize performance with expected traffic

If a two way link is used then the receiver can verify characteristics more easily by programming variations and patterns of the transmitted signals. It will be understood that the foregoing description is merely illustrative of the kinds of intelligence which may be realized in a receiver designed according to the various embodiments of the invention, and that the scope of the present invention includes any use of a power detection signal or additional IF signal to optimize receiver performance.

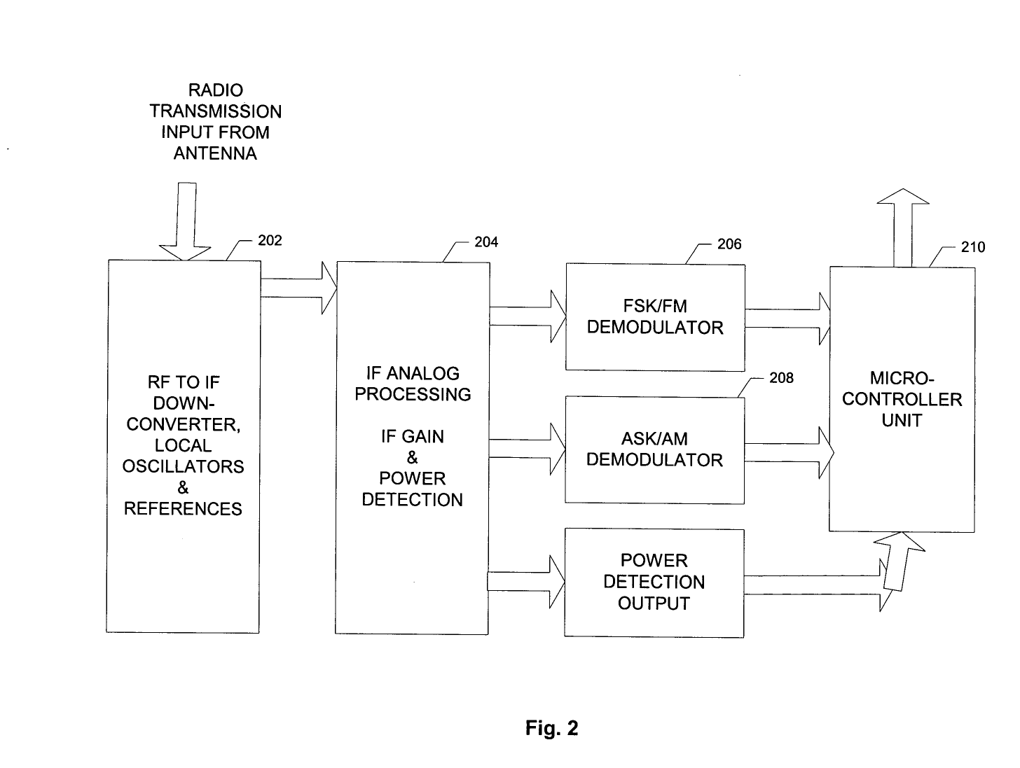

According to other specific embodiments, multiple demodulated signals are provided to multiple inputs of the MCU or some other intermediate conditioning circuits including external demodulators and multiplexers. These embodiments allow simultaneous decoding of information encoded in multiple formats. As will be described, and according to some of these embodiments, the demodulation can be done entirely or at least partially in the MCU. An example of a multiple output embodiment is shown in FIG. 2.

In this embodiment, down converter 202 receives the RF signal and generates an IF signal which is processed by IF processor 104 in the manner described above with reference to FIG. 1. Appropriately processed IF signals are received and demodulated by demodulators 206 and 208 which, according to the depicted embodiment, comprise FSK/FM and ASK/AM demodulators, respectively. According to a specific embodiment, demodulators 206 and 208 operate independently, i.e., their on and off states are not interdependent. The power detection signal is provided to MCU 210, which also receives the demodulated signals from demodulators 206 and 208 directly.

This approach provides a great deal of flexibility to the system designer. For example, the demodulated signals may be simultaneously demodulated and then decoded using multiple capture blocks within MCU 210. Alternatively, if a simpler MCU (e.g., having only one capture block) is desired, a selector may be inserted between the demodulators and the MCU to achieve a design similar to that described above with reference to FIG. 1 in which the decoding of the demodulated signals is done according to some time division scheme.

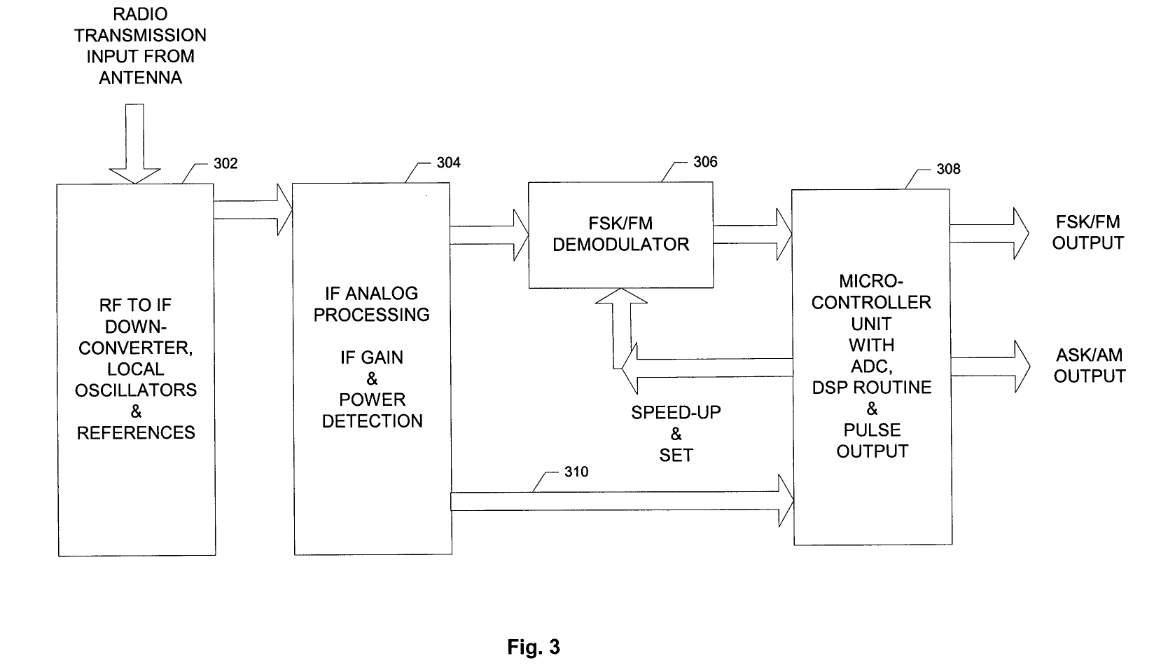

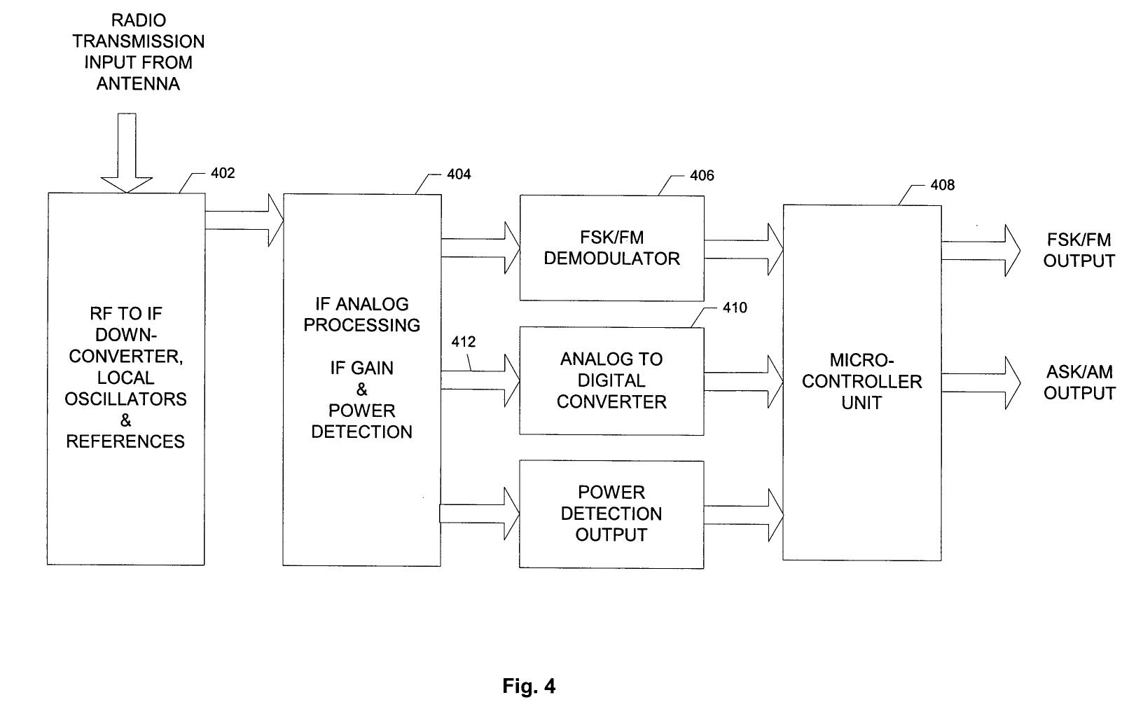

Another set of embodiments incorporates both hardware and software based receivers in a multiple format RF sub-system. According to various ones of these embodiments, the resources necessary to implement the embodiments can be external to a receiver chip or integrated into it. Some exemplary embodiments are shown in FIGS. 3 and 4. As with the embodiments described above, the formats of FSK/FM and ASK/AM are shown in these figures to illustrate the practical application of these embodiments for use in a particular application, e.g., a combined automotive Remote Keyless Entry (RKE) and Tire Pressure Monitoring System (TPMS). As mentioned above, the embodiments described herein can be generalized to most transmission formats and frequency ranges.

Referring to FIG. 3, down converter 302 generates an IF signal from a received RF signal which is then processed by IF processor 304 in a manner similar to that described above with reference to FIGS. 1 and 2. By contrast, in this embodiment, only one hardware demodulator 306 (in this example an FSK/FM demodulator) is provided to receive and demodulate the processed IF signal. As with previous embodiments, IF processor 304 may also generate a power detection signal which is representative of the power in the IF signal, e.g., proportional to the log of the power in the IF signal. According to one embodiment, the power detection signal (represented by 310) is processed by a software demodulator which is implemented entirely in MCU 308. According to another embodiment, signal 310 comprises a second IF signal generated in parallel with the IF signal received by demodulator 306. Thus, embodiments of the present invention process the power detection signal or another IF signal with a digital demodulator to produce one or more valid outputs when signals with one or more formats are received.

According to a specific embodiment, MCU 308 performs an analog-to-digital conversion (ADC) of the power detection or second IF signal and digitally processes the converted signal to generate a demodulated and decoded output signal according to any of a variety of modulation and encoding schemes. This output signal is in addition to the output which results from the decoding of the demodulated signal from demodulator 306. In the example shown, the outputs from MCU 308 are an FSK/FM output and an ASK/AM output, the former from the hardware demodulator and the latter from the software demodulator. In the case of ASK/AM modulations, digital demodulation can be performed on the signal once offsets are corrected and a slicing threshold is calculated.

As with the previously described embodiments, it should be understood that these modulation formats are merely exemplary and that a wide variety of formats and combinations thereof are within the scope of the invention. That is, the hardware and software demodulators which operate on an IF signal can implement any modulation or encoding scheme. For the embodiments which employ the software demodulator to demodulate the power detection signal, only amplitude modulation schemes (e.g., ASK/AM) may be employed because of the loss of the necessary frequency and/or phase information resulting from the manner in which the power signal is typically generated.

According to some embodiments, the second IF signal (and the power detection signal if it has a bandwidth at or above the base band data rate), can be digitized and processed by a digital signal processor implemented in the MCU to extract additional information as well as signaling levels. For example, packet duration and repetition rate can be measured for multiple formats along with quickly sensing packet collisions between packets of similar or different formats. In addition, information to assist both the hardware and software based demodulations (e.g., decision thresholds) can also be extracted and used to optimize the demodulation processes and speed the acquisition time of the receiver after turn-on or mode switching. It should be noted that the term “digital signal processor” as used herein is intended to generically refer to any circuits, logic, or software which process digital signals in any way for any purpose such as, for example, a digital demodulator or channel monitor.

It should also be understood that the present invention encompasses many variations of the exemplary embodiment shown in FIG. 3. For example, specific embodiments of the invention may operate with a single demodulator at a time, employing the one or more additional receiver sub-sections to study the multiple transmission formats received, thereby adding intelligence to the reception process. This extends the receiver's functionality to include optimal reception of the radio channel's packetized traffic in real time, even when the system is one way.

Other advantages associated with various embodiments include channel utilization and DC power consumption optimization, packet error rate minimization and collision detection along with hardware cost optimization. The basis for these optimizations is the ability to observe multiple formats at the same time. This may in turn be used, for example, to minimize the time the receiver is “blind” to a format and allow a complete mapping of the channel traffic. Such a mapping of the channel traffic allows prediction of future transmissions and control of receiver functionality and dissipation.

A particular variation of the embodiment of FIG. 3 is shown in FIG. 4. According to this embodiment, the digitization of the power detection signal or second IF signal (arrow 412) from IF processor 404 is not performed by MCU 408, but by an external digitizer, e.g., ADC 410. It will be understood that a variety of digitizer types may be used as appropriate for a particular application. In this embodiment, a portion of the all-MCU based demodulator of FIG. 3 is moved outside of the MCU into the hardware domain. Thus, MCU 408 receives a demodulated signal from hardware demodulator 406, a digitized version of the power detection signal or second IF signal from ADC 410, and the power detection signal itself.

MCU 408 is shown generating two decoded output signals (e.g., FSK/FM and ASK/AM outputs). However, it will be understood that the embodiment of FIG. 4 may be configured to provide only a single decoded output at a given time (e.g., with a hardware selector, or with software multiplexing within MCU 408) according to any of a wide variety of modulation and/or encoding schemes. Additionally, MCU 408 may be implemented with one or multiple capture/decoding blocks which alternately or simultaneously demodulate and/or decode the received signals.

In any embodiments of the invention employing any combination of hardware and software based demodulators, the power detection signal (e.g., the RSSI) or the second IF signal can be used in a conventional manner as well as processed by the MCU to extract timing and collision information, to generate a demodulated and decoded output signal, or for any of a variety of purposes. For example, a receiver can be designed according to particular embodiments of the invention to support both FSK and ASK modulation formats with different base band encoding, packet lengths and data rates. The packetized RF bursts transmitted to this dual mode receiver may need to be received without the benefit of a reverse channel to coordinate transmissions and therefore packet arrival timing. By observing these packets in more detail using the power detection signal or the second IF signal, the receiver can be trained to anticipate them instead of simply polling and reacting.

In another example, a software based demodulator listens to the channel thru the IF processor's RSSI output or the second IF signal. Based upon these observations, the MCU decides when a hardware demodulator is to be powered up. According to another embodiment, a hardware demodulator can be set to the optimum coefficients for one type of signal and then switched to another set of coefficients based on the results of the channel monitoring. In addition, a software based demodulator can also demodulate one type of signal while the hardware demodulator processes another. Monitoring of the power detection signal or second IF signal could also be used to guide the receiver subsystem in shutting down various parts of the subsystem periodically to reduce long term power consumption.

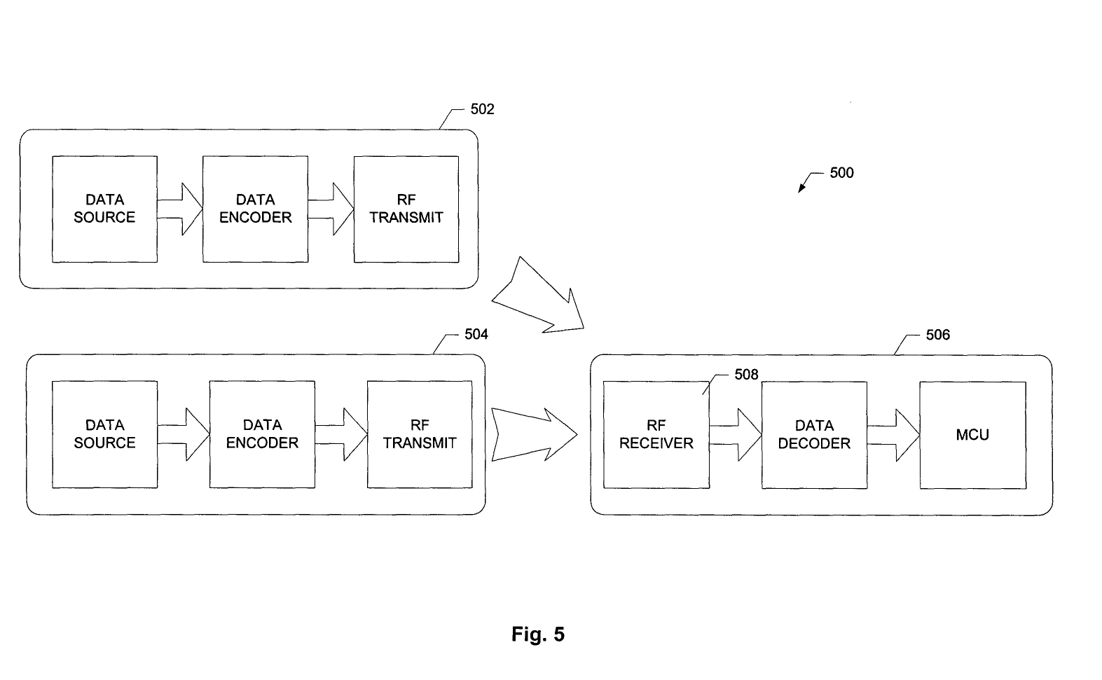

It should be apparent to those of skill in the art that the various embodiments of this invention may be employed in both one-way radio systems (where the transmitters cannot listen to the receiver), and two-way systems (where some or all of the radio components form a transmission loop). FIG. 5 shows a generalized embodiment of a one way system 500 which is operable to employ multiple modulation and encoding formats. A wide variety of modulation formats may be employed in such a system including, for example, FSK/FM, ASK/AM, BPSK, QPSK, PSK, OQSPK, N-PSK, N-QAM, and differentially encoded variants thereof. In addition, various conventional and proprietary encoding schemes, e.g., PWM, PPM, Manchester, Differential Manchester, etc., may be employed in combination with such modulation formats without departing from the invention.

A first transmitter 502 transmits an RF signal according to a first modulation format, and a second transmitter 504 transmits an RF signal according to a second modulation format, to a multi-format receiver 504 designed according to the present invention and which is operable to receive both the first and second modulation formats. According to various embodiments, the receive circuitry 508 may be implemented using any of the embodiments of the invention, including configurations described above with reference to FIGS. 1-4, and any variation thereof.

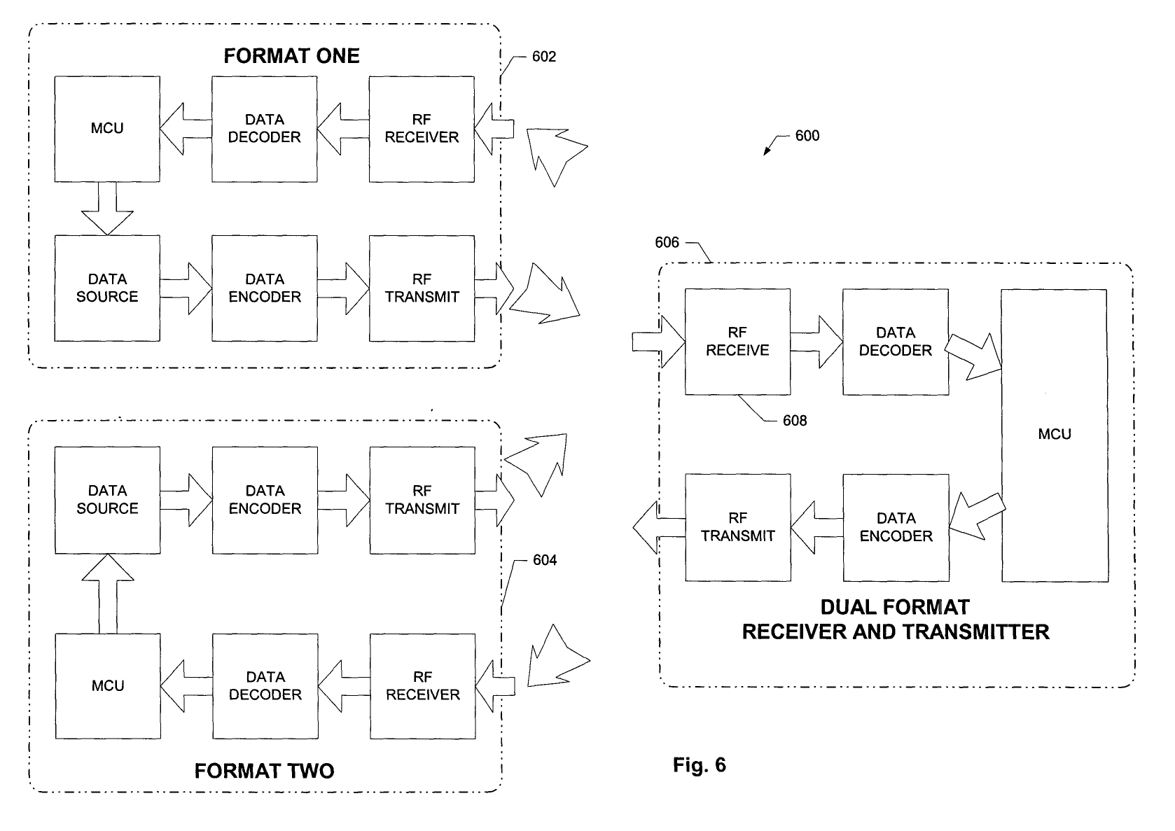

FIG. 6 shows a generalized embodiment of a two way system 600 which is operable to employ multiple modulation and encoding formats. A first transceiver 602 is operable to transmit and receive signals according to a first modulation format. A second transceiver 604 is operable to transmit and receive signals according to a second modulation format. As mentioned above, a wide variety of modulation formats may be employed in such a system. A multi-format transceiver 606 implemented according to a specific embodiment of the invention is operable to transmit and receive signals in either of the first and second modulation formats. Receive circuitry 608 may also be implemented according to any of the embodiments of the invention.

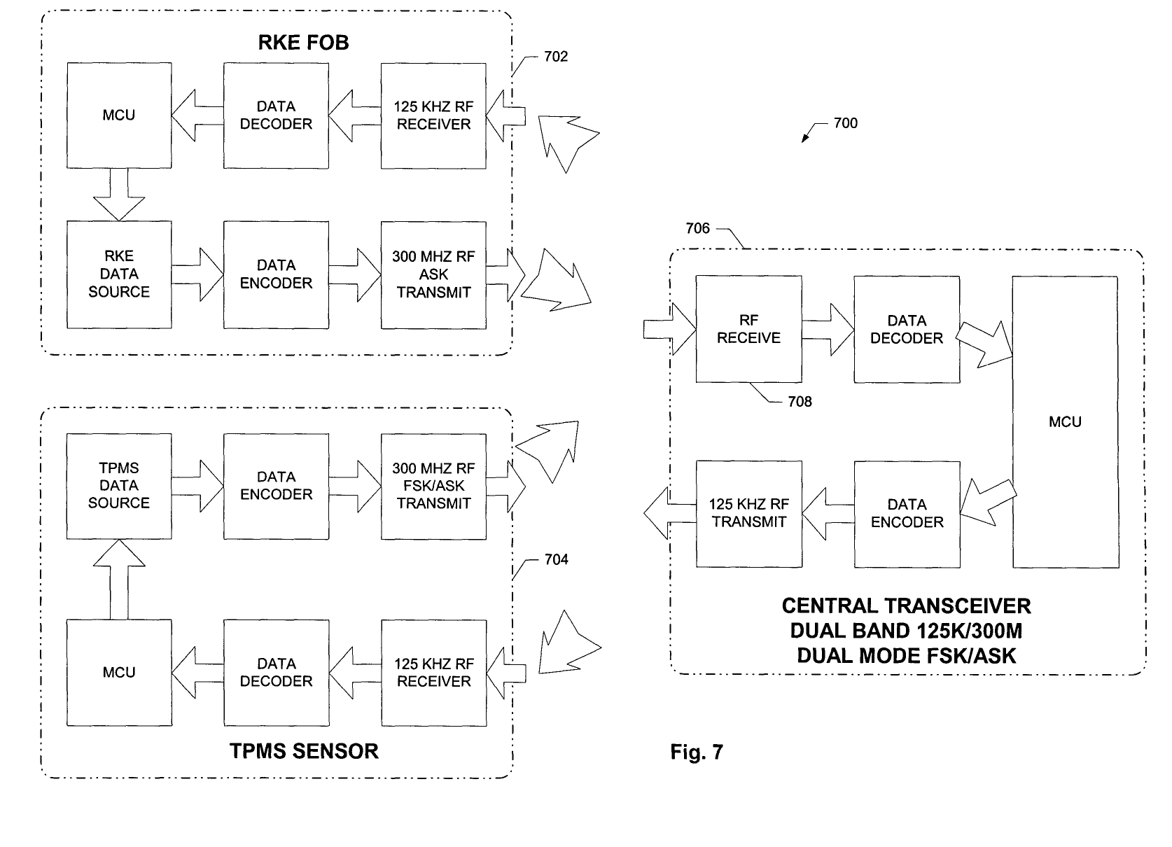

A more specific implementation of a two way system according to the invention is shown in FIG. 7 in which one path operates at 300 MHz and the return path at 125 KHz. A first transceiver 702 is a remote keyless entry (RKE) device which is operable to transmit an ASK/AM signal at 300 MHz and receive an ASK/AM signal at 125 kHz. A second transceiver 704 is a tire pressure monitoring system (TPMS) device which is operable to transmit an FSK/FM signal at 300 MHz and receive an FSK/FM signal at 125 kHz. The specific implementations of transceivers 702 and 704 are not particularly germane to the invention and will therefore not be discussed in detail. It is sufficient to note that these types of devices are well known and that embodiments of the invention may be implemented using any such devices.

A dual band, dual format transceiver 706 receives the 300 MHz transmissions from transceivers 702 and 704 in both formats using a dual format receiver 708 designed according to any of the embodiments of the present invention. Transceiver 706 also transmits 125 kHz signals to transceivers 702 and 704. According to various specific embodiments, transceiver 706 is configured to listen for the signals from both of transceivers 702 and 706 by controlling the timing of their transmissions thru the return link. According to an alternate embodiment, transceiver 706 “learns” the transmission pattern by channel monitoring.

An example of “learning” the transmission pattern by channel monitoring is template matching. A particular transmission format will have a nominal data rate, encoding and packet structure. This information and it's expected variation is entered into the MCU memory. When an individual transmitter that sends a signal to the receiver it will typically have an offset time base or RF frequency which requires compensation at the receiver. By measuring packet duration the time base offset can be measured very easily, increasing both the probability of reception and the accuracy of the receiver “intelligent polling”. The RF frequency offset due to synthesizer error can be derived from the IF replica or demodulator output, allowing the receiver to “tune” more precisely to the expected transmitter. This speeds acquisition and indirectly minimizes power consumption.

While the invention has been particularly shown and described with reference to specific embodiments thereof, it will be understood by those skilled in the art that changes in the form and details of the disclosed embodiments may be made without departing from the spirit or scope of the invention. For example, it should be understood that various embodiment described herein are operable to switch between receiver modes in a variety of manners to suit particular applications. For example, in some automotive applications, transmitters may switch mode based on whether the automobile is turned on or off. Thus, a receiver designed according to a specific embodiment of the invention might be configured initially in ASK mode when the car is off and both the RKE and TPMS transmitters are in ASK mode. However, when the car turns on and starts to move and the TPMS transmitter switches to FSK mode, the receiver may do so also to follow. Indeed, with the techniques described herein, the receiver could be configured to switch modes within a packet!

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

1. A radio frequency (RF) receiver, comprising:
a down-converter operable to convert a received RF signal to an intermediate frequency (IF) signal, the down-converter also being operable to generate a power detection signal representative of a power level associated with the received RF signal;
a hardware demodulator operable to demodulate the IF signal in accordance with a first modulation format and thereby generate a first demodulated signal; and
a digital signal processor operable to process the power detection signal in accordance with a second modulation format and thereby generate a second demodulated signal.

2. The RF receiver of claim 1 wherein the power detection signal comprises a received signal strength indicator (RSSI signal).

3. The RF receiver of claim 1 wherein the first modulation format comprises one of an amplitude modulation format, a frequency modulation format, a phase modulation format, and a complex modulation format.

4. The RF receiver of claim 1 wherein the second modulation format comprises an amplitude modulation format.

5. The RF receiver of claim 1 wherein the first modulation format comprises frequency shift keying (FSK), and wherein the second modulation format comprises amplitude shift keying (ASK).

6. The RF receiver of claim 1 further comprising a micro-controller operable to decode the first and second demodulated signals.

7. The RF receiver of claim 6 wherein the micro-controller is further operable to implement at least a portion of the digital signal processor.

8. The RF receiver of claim 7 wherein the digital processor comprises a digitizer which is operable to digitize the power detection signal.

9. The RF receiver of claim 8 wherein the digitizer is external to the micro-controller.

10. The RF receiver of claim 8 wherein the digitizer is implemented in the micro-controller.

11. The RF receiver of claim 6 wherein the micro-controller is further operable to output decoded versions of the first and second demodulated signals simultaneously.

12. The RF receiver of claim 1 wherein the digital signal processor is further operable to process the power detection signal to extract information to facilitate any of reception of packetized traffic, channel utilization, power consumption optimization, packet error rate minimization, collision detection, hardware optimization, and demodulation optimization.

13. An electronic system comprising the RF receiver of claim 1.

14. The electronic system of claim 13 wherein the electronic system comprises a combination of a remote keyless entry (RKE) system and tire pressure measurement system (TPMS).

15. A vehicle comprising the electronic system of claim 14.

16. The electronic system of claim 13 wherein the electronic system comprises a one-way, open loop system.

17. The electronic system of claim 13 wherein the electronic system comprises a two-way, closed loop system.

18. A radio frequency (RF) receiver, comprising:
a down-converter operable to convert a received RF signal to at least one intermediate frequency (IF) signal;
a first demodulator operable to demodulate the IF signal in accordance with a first modulation format and thereby generate a first demodulated signal;
a second demodulator operable to demodulate the IF signal in accordance with a second modulation format and thereby generate a second demodulated signal;
a micro-controller operable to decode the first and second demodulated signals; and
a selector operable to simultaneously receive the first and second demodulated signals and to provide only one of the first and second demodulated signals to the micro-controller at a time.

19. The RF receiver of claim 18 wherein the down-converter is further operable to generate a power detection signal representative of a power level associated with the received RF signal.

20. The RF receiver of claim 19 further comprising a digital signal processor operable to process the power detection signal to extract information to facilitate any of reception of packetized traffic, channel utilization, power consumption optimization, packet error rate minimization, collision detection, hardware optimization, and demodulation optimization.

21. The RF receiver of claim 20 wherein the micro-controller is further operable to implement at least a portion of the digital signal processor.

22. The RF receiver of claim 19 wherein the power detection signal comprises a received signal strength indicator (RSSI signal).

23. The RF receiver of claim 18 wherein the first modulation format comprises one of an amplitude modulation format, a frequency modulation format, a phase modulation format, and a complex modulation format.

24. The RF receiver of claim 18 wherein the second modulation format comprises one of an amplitude modulation format, a frequency modulation format, a phase modulation format, and a complex modulation format.

25. The RF receiver of claim 18 wherein the first modulation format comprises frequency shift keying (FSK), and wherein the second modulation format comprises amplitude shift keying (ASK).

26. An electronic system comprising the RF receiver of claim 18.

27. The electronic system of claim 26 wherein the electronic system comprises a combination of a remote keyless entry (RKE) system and tire pressure measurement system (TPMS).

28. A vehicle comprising the electronic system of claim 27.

29. The electronic system of claim 26 wherein the electronic system comprises a one-way, open loop system.

30. The electronic system of claim 26 wherein the electronic system comprises a two-way, closed loop system.

31. A radio frequency (RF) receiver, comprising:
a down-converter operable to convert a received RF signal to at least one intermediate frequency (IF) signal;
a hardware demodulator operable to demodulate the IF signal in accordance with a first modulation format and thereby generate a first demodulated signal;
a software demodulator operable to demodulate the IF signal in accordance with a second modulation format and thereby generate a second demodulated signal; and
a micro-controller operable to simultaneously decode the first and second demodulated signals.

32. The RF receiver of claim 31 wherein the down-converter is further operable to generate a power detection signal representative of a power level associated with the received RF signal.

33. The RF receiver of claim 32 further comprising a digital signal processor operable to process the power detection signal to extract information to facilitate any of reception of packetized traffic, channel utilization, power consumption optimization, packet error rate minimization, collision detection, hardware optimization, and demodulation optimization.

34. The RF receiver of claim 33 wherein the micro-controller is further operable to implement at least a portion of the digital signal processor.

35. The RF receiver of claim 32 wherein the power detection signal comprises a received signal strength indicator (RSSI signal).

36. The RF receiver of claim 31 wherein the first modulation format comprises one of an amplitude modulation format, a frequency modulation format, a phase modulation format, and a complex modulation format.

37. The RF receiver of claim 31 wherein the second modulation format comprises one of an amplitude modulation format, a frequency modulation format, a phase modulation format, and a complex modulation format.

38. The RF receiver of claim 31 wherein the first modulation format comprises frequency shift keying (FSK), and wherein the second modulation format comprises amplitude shift keying (ASK).

39. The RF receiver of claim 31 further comprising a digital signal processor operable to process the IF signal to extract information to facilitate any of reception of packetized traffic, channel utilization, power consumption optimization, packet error rate minimization, collision detection, hardware optimization, and demodulation optimization.

40. The RF receiver of claim 31 wherein the micro-controller is also operable to decode the first and second demodulated signals independently.

41. An electronic system comprising the RF receiver of claim 31.

42. The electronic system of claim 41 wherein the electronic system comprises a combination of a remote keyless entry (RKE) system and tire pressure measurement system (TPMS).

43. A vehicle comprising the electronic system of claim 42.

44. The electronic system of claim 41 wherein the electronic system comprises a one-way, open loop system.

45. The electronic system of claim 41 wherein the electronic system comprises a two-way, closed loop system.

46. A radio frequency (RF) receiver, comprising:
a down-converter operable to convert a received RF signal to an intermediate frequency (IF) signal, the down-converter also being operable to generate a power detection signal representative of a power level associated with the received RF signal;
a demodulator operable to demodulate the IF signal in accordance with a first modulation format and thereby generate a first demodulated signal;
a digital signal processor operable to process one of the IF signal and the power detection signal to extract information to facilitate any of reception of packetized traffic, channel utilization, power consumption optimization, packet error rate minimization, collision detection, hardware optimization, and demodulation optimization.

47. The RF receiver of claim 46 wherein the first modulation format comprises one of an amplitude modulation format, a frequency modulation format, a phase modulation format, and a complex modulation format.

48. The RF receiver of claim 46 wherein the digital signal processor is further operable to process the one of the IF signal and the power detection signal in accordance with a second modulation format and thereby generate a second demodulated signal.

49. The RF receiver of claim 48 further comprising a micro-controller operable to decode the first and second demodulated signals.

50. The RF receiver of claim 49 wherein the micro-controller is further operable to implement at least a portion of the digital signal processor.

51. The RF receiver of claim 50 wherein the digital processor comprises a digitizer which is operable to digitize the power detection signal.

52. The RF receiver of claim 51 wherein the digitizer is external to the micro-controller.

53. The RF receiver of claim 51 wherein the digitizer is implemented in the micro-controller.

54. The RF receiver of claim 48 wherein the micro-controller is further operable to output decoded versions of the first and second demodulated signals simultaneously.

55. The RF receiver of claim 48 wherein the power detection signal comprises a received signal strength indicator (RSSI signal).

56. The RF receiver of claim 48 wherein the first modulation format comprises one of an amplitude modulation format, a frequency modulation format, a phase modulation format, and a complex modulation format.

57. The RF receiver of claim 48 wherein the second modulation format comprises one of an amplitude modulation format, a frequency modulation format, a phase modulation format, and a complex modulation format.

58. The RF receiver of claim 48 wherein the first modulation format comprises frequency shift keying (FSK), and wherein the second modulation format comprises amplitude shift keying (ASK).

59. An electronic system comprising the RF receiver of claim 46.

60. The electronic system of claim 59 wherein the electronic system comprises a combination of a remote keyless entry (RKE) system and tire pressure measurement system (TPMS).

61. A vehicle comprising the electronic system of claim 60.

62. The electronic system of claim 59 wherein the electronic system comprises a one-way, open loop system.

63. The electronic system of claim 59 wherein the electronic system comprises a two-way, closed loop system.
